(19) United States
(12) Patent Application Publication
(10) Pub. No.: US 2021/0094869 A1
(43) Pub. Date: Apr. 1, 2021

(54) Glass Container, And Method And Apparatus For Manufacturing The Same

(71) Applicant: TOYO-SASAKI GLASS CO., LTD., Tokyo (JP)

(72) Inventors: Noriaki SHIBATA, Yachiyo-Shi (JP); Kouichi SAWAFUJI, Yachiyo-Shi (JP); Toshiyuki MISU, Yachiyo-Shi (JP)

(21) Appl. No.: 17/117,596

(22) Filed: Dec. 10, 2020

Related U.S. Application Data
(62) Division of application No. 16/096,170, filed on Oct. 24, 2018.

(30) Foreign Application Priority Data
May 12, 2016 (JP) 2016-096192

(51) Int. Cl. C03C 17/245; C03B 32/00; A47G 19/00; A47G 19/22; B65D 23/08; A47G 19/02; B65D 1/02

(52) U.S. Cl. CPC C03C 17/2456; C03B 32/00; A47G 19/00; A47G 19/22; B65D 23/08; C03C 17/245; C03C 2218/31; A47G 19/2205; B65D 1/0215; B65D 23/0814; C03C 2217/212; C03C 2217/78; C03C 2218/152; A47G 19/02

(57) ABSTRACT

A glass container has a container main body made of glass and a coating film formed on a surface of the container main body. The coating film is made of tin oxide or titanium oxide, and the film thickness of the coating film ranges from 40 nm to 50 nm. In the depth profile obtained by X-ray photoelectron spectroscopy (XPS) analysis, an atomic percentage of sodium at a point where a tin or titanium profile intersects a silicon profile is 2% or less.

### CROSS REFERENCE TO RELATED APPLICATIONS

This application is a divisional of U.S. patent application Ser. No. 16/096,170, filed on Oct. 24, 2018, which claims priority to International Application No. PCT/JP2017/015566 filed on Apr. 18, 2017 and published in Japanese as WO 2017/195539 A1 on Nov. 16, 2017 which claims the benefit of priority from Japanese Patent Application No. 2016-096192 filed on May 12, 2016. The entire disclosures of all of the above applications are incorporated herein by reference.

### BACKGROUND

### Technical Field

The invention relates to a glass container having a coating film excellent in scratch resistance and alkali resistance, such that scratching of the glass container can be prevented, and method and apparatus for manufacturing same.

### Related Art

Glass containers can be scratched on the surface of the glass and the appearance of the glass container can be degraded due to contact between glass and glass or other objects. Furthermore, scratches are likely to cause chipping or breakage of the glass containers. In particular, glass containers for business use are often carried in large numbers at the same time, so that glass containers can collide with each other, which results in scratches on the glass containers. The scratches of the glass containers are further increased in size by repeated use which often leads to chipping and breakage. In addition, when there is a difference in temperature in a glass container due to use of a dishwasher, a scratch may become a breakage starting point and lead to breakage of the glass container.

Therefore, techniques for strengthening glass have been developed in order to prevent the occurrence of such scratches and to increase the strength of glass containers. As a typical strengthening technique, for example, chemical strengthening such as a method of replacing alkali ions in glass with other alkali ions to form a compressive stress layer on the glass surface is known. However, since chemical strengthening is secondary processing performed on molded and gradually cooled products, the processing is time consuming and costly. Further, the compressive stress layer on the surface of the glass product formed by chemical strengthening is thin, so that expected hardness and scratch strength cannot be obtained and sufficient scratch resistance cannot be obtained.

A technique for increasing the scratch resistance effect by forming a coating film of tin oxide or titanium oxide on a glass surface of a glass bottle is also already known. In the case of a general one-way bottle, a coating film of an oxide such as tin oxide or titanium oxide having a thickness of about 12 nm to 15 nm is formed on the surface of glass immediately after the bottle is produced and before the gradual cooling. However, since sufficient scratch resistance cannot be obtained only with this coating film, a polyethylene-based resin coating film is further formed on the oxide coating film after gradual cooling to impart scratch resistance. However, the bottles treated in this way do not have sufficient alkali resistance, and in particular, polyethylene-based resin components are immediately peeled off with an alkaline cleaning liquid. Further, when the bottle is repeatedly washed in a dishwasher, the oxide coating film easily peels off itself, and iris phenomenon and whitening phenomenon also occur.

Accordingly, a method has been suggested by which a glass bottle having an outer surface temperature of 550° C. to 700° C. and a raw material for forming a film including SnO₂ or TiO₂ as a main component are brought into contact with each other to form a film including SnO₂ or TiO₂ as a main component and having a thickness of 40 nm to 100 nm JP-A-3-131547. Although a glass bottle prepared by this method has improved alkali resistance, when the bottle is repeatedly washed with a dishwasher, alkali resistance is still insufficient and scratch resistance is also insufficient. In addition, the glass bottle produced by this method is not suitable for a glass container that emphasizes aesthetic appearance, since an iris tends to occur when the coating film is thick.

JP-A-2000-302483 and JP-A-2001-146438 suggest treatment methods for obtaining a glass bottle which excels in alkali resistance and in which the coating film is not so thick as to cause an iris. JP-2000-302483 discloses a glass bottle on which a coating film of tin oxide or titanium oxide having a film thickness of 8 nm to 40 nm is formed and JP-2001-146438 discloses a glass bottle on which a tin oxide film having a film thickness of 10 nm to 40 nm is formed. Further, JP-A-8-133786 discloses glass tableware on which an oxide coating film having a thickness of 1 nm to 30 nm is formed. However, with the techniques disclosed in JP-2000-302483; JP-2001-146438; and JP-8-133786, hardness and scratch strength of the coating films which are required for practical use cannot be obtained, so that sufficient scratch resistance as a glass container cannot be obtained, and alkali resistance which is sufficient to withstand repetitive washing cannot be obtained.

It is an object of the invention to provide a high-strength glass container in which as a result of forming an oxide coating film that excels in scratch resistance and alkali resistance and does not generate an iris color, the aesthetic appearance of the glass container is not impaired, no whitening occurs even in repeated use of a dishwasher, scratches are prevented, and breakage of the glass container can be reduced. Another object of the invention is to provide method and apparatus for manufacturing such a glass container.

### SUMMARY

A glass container according to an embodiment of the invention comprises:
a container main body made of glass; and
a coating film formed on a surface of the container main body,
the coating film being made of tin oxide or titanium oxide,
the coating film having a film thickness ranging from 40 nm to 50 nm, and
in a depth profile obtained by X-ray photoelectron spectroscopy (XPS) analysis, an atomic percentage of sodium at a point where a tin or titanium profile intersects a silicon profile being 2% or less.

In the glass container, the coating film may have a surface hardness ranging from 7000 N/mm² to 8500 N/mm² determined by an ultra-low loaded hardness test according to JIS Z 2255:2003.

In the glass container, the coating film may have a surface roughness (Rms) measured by an atomic force microscope (AFM) of 15 nm or less.

In the glass container, the coating film may have a scratch strength of 8 kg or more.

In the glass container, the coating film may be formed on at least an outer side surface of the container main body.

The glass container may be a jug, a tumbler, a bowl, a dish, a stem glass (glass with a leg), a mug, or a bottle.

A method for manufacturing a glass container according to an embodiment of the invention comprises:
a first step of molding a container main body made of glass;
a second step of conducting heat treatment while maintaining the container main body at a temperature of 580° C. or higher to desorb sodium in a surface region of the container main body; and
a third step of forming a coating film of tin oxide or titanium oxide having a film thickness ranging from 40 nm to 50 nm on a surface of the container main body.

In the method for manufacturing a glass container, the temperature of the container main body in the second step may range from 600° C. to 770° C.

In the method for manufacturing a glass container, the heat treatment in the second step may be a flame treatment.

In the method for manufacturing a glass container, in the flame treatment, the flame temperature may range from 1250° C. to 1600° C., and the flame contact time may range from 0.5 sec to 2 sec. Further, in the flame treatment, the flame temperature may range from 1290° C. to 1580° C., and the flame contact time may range from 0.8 sec to 2 sec.

An apparatus for manufacturing a glass container according to an embodiment of the invention comprises:
a molding device that molds a container main body made of glass;
a heating device that heats the container main body formed by the molding device, while the container main body is rotated;
a coating film forming device that forms a coating film of tin oxide or titanium oxide on a surface of the container main body heat-treated by the heating device; and
a gradual cooling device that gradually cools the glass container on which the coating film has been formed.

In the apparatus for manufacturing a glass container, the heating device may be a burner.

In the apparatus for manufacturing a glass container,
the heating device and the coating film forming device may be provided along a conveying device; and
the conveying device may have a plurality of tables on which the container main body and the glass container can be placed and which is rotatable in a predetermined direction, the plurality of tables being arranged in a loop shape and continuously movable in a predetermined direction.

### Advantageous Effects of Invention

According to the invention, it is possible to provide a high-strength glass container in which as a result of forming an oxide coating film that excels in scratch resistance and alkali resistance and does not generate an iris color, the aesthetic appearance of the glass container is not impaired, no whitening occurs even in repeated use of a dishwasher, scratches are prevented, and breakage of the glass container can be reduced. According to the invention, it is also possible to provide method and apparatus for manufacturing such a glass container.

### BRIEF DESCRIPTION OF DRAWINGS

FIG. 1 is a perspective view schematically illustrating an apparatus for manufacturing a glass container according to an embodiment.

FIG. 2 is a broken view schematically illustrating an example of a glass container according to an embodiment.

FIG. 3 is a chart illustrating a depth profile according to an embodiment which is determined by XPS analysis.

FIG. 4 is a chart illustrating a depth profile according to a Comparative Example which is determined by XPS analysis.

FIG. 5 is a chart illustrating the relationship between the flame temperature and the flame treatment time of samples according to Examples and Comparative Examples.

FIG. 6 is a chart illustrating the relationship between the flame temperature and the flame treatment time of samples according to Comparative Examples.

FIG. 7 is an electron micrograph of the surface of a coating film according to an Example.

FIG. 8 is an electron micrograph of the surface of a coating film according to a Comparative Example.

FIG. 9 is an image obtained by an atomic force microscope according to an Example.

FIG. 10 is an image obtained by an atomic force microscope according to an Example.

FIG. 11 is an image obtained by an atomic force microscope according to an Example.

FIG. 12 is an image obtained by an atomic force microscope according to an Example.

FIG. 13 is an image obtained by an atomic force microscope according to a Comparative Example.

FIG. 14 is an image obtained by an atomic force microscope according to a Comparative Example.

FIG. 15 illustrates a method for measuring a scratch strength.

FIG. 16 is a chart illustrating the relationship between the film thickness of the coating film and the scratch generation load in the scratch strength.

FIG. 17 is a chart illustrating the relationship between the temperature of the container main body and the scratch generation load in the heating step in the scratch strength.

### DETAILED DESCRIPTION

Hereinafter, exemplary embodiments of the invention will be described, but the invention is not limited thereto.

### 1. Apparatus and Method for Manufacturing Glass Container

### 1.1. Manufacturing Apparatus

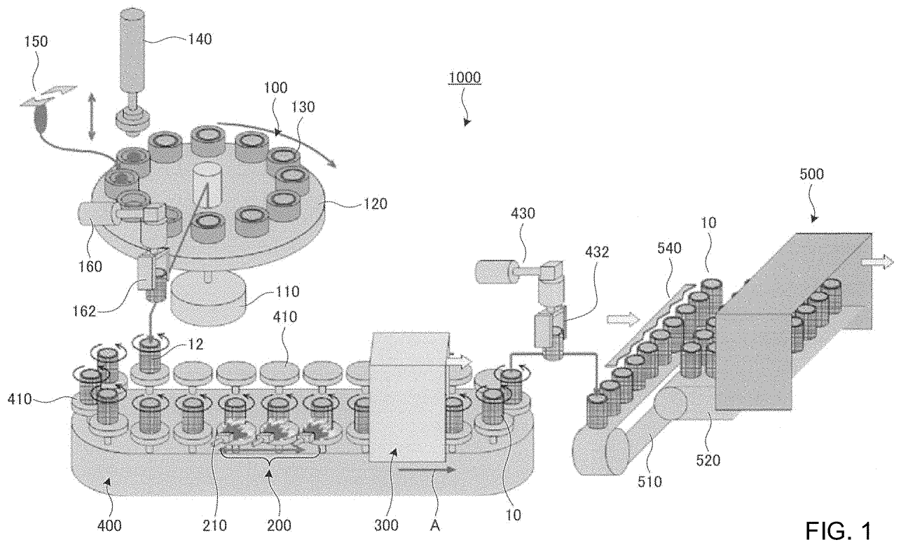

First, an apparatus for manufacturing a glass container according to an embodiment of the invention will be described. FIG. 1 schematically illustrates an example of a manufacturing apparatus 1000 according to an embodiment of the invention.

As depicted in FIG. 1, the manufacturing apparatus 1000 includes a molding device 100 for molding a container main body 12 made of glass, a heating device 200 for heating the container main body 12, a coating film forming device 300 for forming a film of tin oxide or titanium oxide on the surface of the container main body 12, and a gradual cooling device 500 for gradually cooling the glass container 10 on which the coating film has been formed. The heating device 200 and the coating film forming device 300 are provided along a conveying device 400.

The molding device 100 has a table 120 rotatably provided on a support part 110 and a plurality of molds 130 arranged on the table 120. Above the table 120, a cylinder 140 capable of vertical movement and a cutter 150 for cutting molten glass are provided. By moving the cylinder 140 downward, the molten glass in the mold 130 can be molded.

The conveying device 400 has a plurality of tables 410 on which the container main body 12 and the glass container 10 can be placed. These tables 410 are disposed adjacent to each other in a loop shape, and each table 410 is provided so as to be rotatable in a predetermined direction. Further, the plurality of tables 410 arranged in a loop shape are continuously moved in a direction indicated by a symbol A (a counterclockwise direction in FIG. 1) by a driving device (not shown).

A transfer device 160 for transferring the container main body 12 from the molding device 100 to the conveying device 400 is provided between the molding device 100 and the conveying device 400. The transfer device 160 has a grip 162. By moving the grip 162, it is possible to transfer the container main body 12 while holding the container main body.

The heating device 200 is disposed at a position where the container main body 12 on the table 410 can be heated. In this example, the heating device 200 has a plurality of burners 210 arranged along the transfer direction of the container main body 12. Since the container main body 12 is rotated by the rotation of the table 410, the flame from the heating device 200 is uniformly radiated on the outer surface of the container main body 12.

The coating film forming device 300 is provided adjacent to the heating device 200. The interior of the coating film forming device 300 is kept at a predetermined temperature and has means for supplying raw material gas (not shown). In the coating film forming device 300, the source gas is supplied toward at least the outer side surface of the container main body 12.

In the gradual cooling device 500, there is provided a gradual cooling means using gas or electric heating (not shown). A first conveyor 510 and a second conveyor 520 are provided between the conveying device 400 and the gradual cooling device 500. A transfer device 430 for transferring the glass container 10 on which the coating film has been formed from the conveying device 400 to the first conveyor 510 is provided between the conveying device 400 and the first conveyor 510. The transfer device 430 has a grip 432. By moving the grip 432, the glass container 10 can be transferred in a state of being grasped by the grip. The glass container 10 placed on the first conveyor 510 can be moved to the second conveyor 520 by a pusher 540.

### 1.2. Manufacturing Method

In the method for manufacturing a glass container according to an embodiment of the invention, the glass container 10 can be manufactured using the abovementioned manufacturing apparatus. The manufacturing method according to the present embodiment includes a first step of molding the container main body 12 made of glass, a second step of conducting heat treatment while maintaining the container main body 12 at a temperature of 580° C. or higher to desorb sodium in a surface region of the container main body 12, and a third step of forming a coating film of tin oxide or titanium oxide having a film thickness ranging from 40 nm to 50 nm on the surface of the container main body 12.

Specifically, in the first step, the container main body 12 is molded by using the molding device 100. The molding device is not limited to the above-described molding device 100, and a known glass forming machine can be used.

In the second step, the container main body 12 is transferred to the table 410 of the conveying device 400 by the transfer device 160. As the table 410 moves, the container main body 12 is transferred to the heating device 200. At this time, the container main body 12 is heat-treated while maintaining the temperature at 580° C. or higher, preferably from 600° C. to 770° C. Further, in the present embodiment, since the burner is used as the heating device 200, flame treatment by oxygen combustion can be used. By using oxygen combustion in the burner, it is possible to heat the desired surface area of the container main body 12 at a high temperature and in a short time. In this case, the flame temperature preferably ranges from 1250° C. to 1600° C., more preferably ranges from 1290° C. to 1580° C. The contact time between the flame and the container main body 12 preferably ranges from 0.5 sec to 2 sec, more preferably ranges from 0.8 sec to 2 sec.

In the second step, as described above, the temperature of the container main body 12 is kept within a predetermined range, and the container main body 12 is heated under predetermined conditions by flame treatment, whereby sodium in the surface region of the glass of the container main body 12 can be desorbed and the concentration thereof can be reduced. As a result, a glass container excellent in alkali resistance and scratch resistance can be formed. The reason for this will be described in detail hereinbelow.

In the third step, the container main body 12 is transferred to the coating film forming device 300 by the conveying device 400, and a coating film of tin oxide or titanium oxide having a film thickness ranging from 40 nm to 50 nm is formed on the surface of the container main body 12. These coating films are formed, for example, by a well-known hot-end coating method. For example, the following raw materials and coating film forming method can be used as a manufacturing method of the coating film.

The raw materials for the coating film are not particularly limited as long as thermal decomposition and/or hydrolysis thereof can form tin oxide or titanium oxide. For example, tin tetrachloride, monobutyl tin trichloride, dimethyl tin dichloride, or the like can be used as the compound of tin, and titanium tetrachloride and the like can be used as the compound of titanium. Other metal compounds can also be added within the scope of the object of the invention. The coating film forming method is not particularly limited as long as a coating film is formed by bringing the raw material gas into contact with the surface of the container main body 12 set to a desired temperature range. The coating film forming method can be exemplified by a chemical vapor deposition method.

As the film forming conditions, the temperature of the raw material gas is preferably 130° C. to 150° C., and the treatment time depends on the temperature of the raw material gas and the film thickness of the film, but is preferably 2 sec to 4 sec.

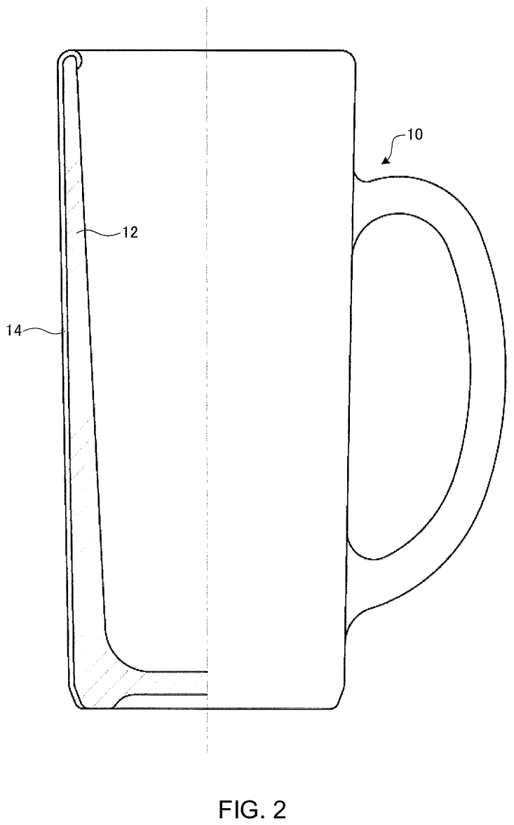

Further, the raw material gas can be supplied depending on the formation region of the coating film. For example, when it is desired to form a coating film on the side surface of the glass container (beer mug) depicted in FIG. 2, the raw material gas is blown to the outer side surface of the container main body 12 and a gas not containing the raw material gas is supplied to the inside of the container main body 12.

### 2. Glass Container

FIG. 2 is a broken view schematically illustrating the glass container 10 according to the present embodiment. In the example depicted in FIG. 2, the glass container 10 is a beer mug, but the glass container 10 is, of course, not limited to the beer mug.

As depicted in FIG. 2, the glass container 10 has a container main body 12 made of glass and a coating film 14 formed on the surface of the container main body 12. The coating film 14 is made of tin oxide or titanium oxide. The film thickness of the coating film 14 ranges from 40 nm to 50 nm, and in the depth profile obtained by X-ray photoelectron spectroscopy (XPS) analysis, the atomic percentage of sodium at a point where a tin or titanium profile intersects a silicon profile is 2% or less.

The container main body 12 is molded of glass, and the glass is not particularly limited and can be soda lime glass or the like.

Next, the coating film 14 will be described. The coating film 14 is made of tin oxide or titanium oxide, and the film thickness thereof ranges from 40 nm to 50 nm. When the film thickness of the coating film 14 is within this range, no iris color occurs and the aesthetic appearance of the glass container 10 is not impaired while ensuring adequate alkali resistance and scratch resistance. The coating film 14 can be formed on the entire surface of the container main body 12, preferably except the bottom surface, but it can also be formed on a part of the surface of the container main body 12, in particular at least on the outer side surface of the container main body 12. By thus forming the coating film 14 on at least the outer side surface of the container main body 12, it is possible to effectively prevent the occurrence of scratches caused by the contact between the glass containers 10.

Further, in the glass container 10, in the depth profile obtained by X-ray photoelectron spectroscopy (XPS) analysis, the atomic percentage of sodium at a point where a tin or titanium profile intersects a silicon profile is 2% or less.

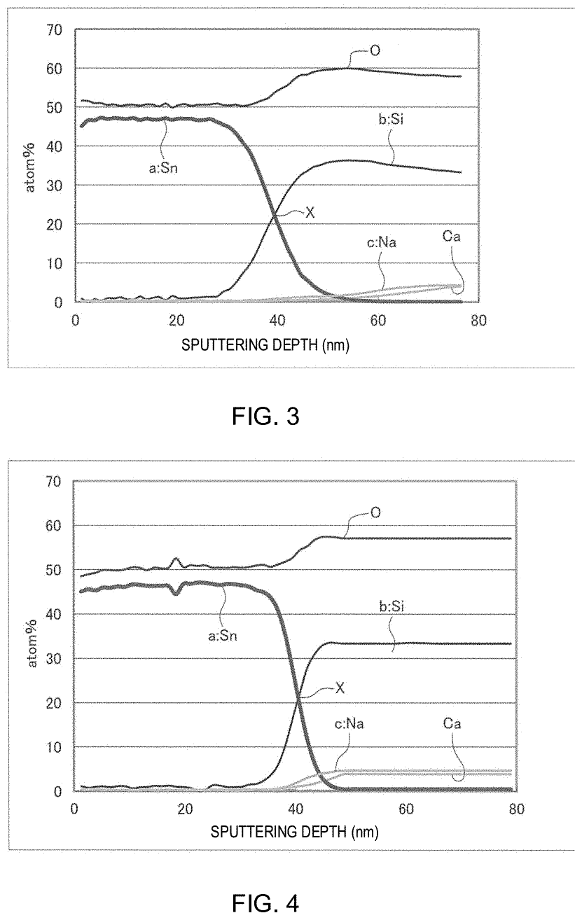

Specifically, as illustrated in FIG. 3, in the depth profile obtained by performing the XPS analysis using the sample of the glass container 10, the atomic percentage (atom %) of the profile c of sodium at the point X where the profile a of tin Sn and the profile b of silicon Si intersect is 2% or less, preferably 1% or less.

FIG. 4 illustrates the depth profile obtained by performing the XPS analysis according to a Comparative Example. As illustrated in FIG. 4, in the Comparative Example, the atomic percentage (atom %) of the profile c of sodium at the point X where the profile a of tin Sn and the profile b of silicon Si intersect is greater than 2%. The data illustrated in FIGS. 3 and 4 will be described in detail hereinbelow in Examples.

By making the sodium concentration in the surface region of the glass container 10 smaller than the specific value in this manner, it is possible to reduce the adverse effect of the sodium salt caused by reaction of sodium with chlorine or the like as the raw material of the coating film 14. As a result, the coating film 14 is dense, has high strength and has no pinholes caused by the sodium salt.

More specifically, as described hereinbelow, a large number of pinholes are generated in the oxide coating film formed by the conventional method. Alkaline cleaning solutions permeate through the pinholes, erosion and expansion of the pinholes occur, and eventually the coating film falls off. For this reason, it seems that the light is scattered and the surface of the glass is whitened. The pinholes are thought to be due to the reaction of sodium in the glass surface region with chlorine contained in the raw material of tin oxide or titanium oxide, this reaction producing sodium chloride crystals and causing the crystals to fall off from the coating film.

According to the invention, since sodium in the surface region of the glass can be eliminated or the amount thereof can be greatly reduced, generation of sodium chloride which causes pinholes can be reduced. As a result, the glass container 10 according to the invention has the following physical properties.

### (1) Surface Hardness

The coating film 14 has a surface hardness preferably ranging from 7000 N/mm² to 8500 N/mm² determined by an ultra-low loaded hardness test according to JIS Z 2255:2003.

Measurement conditions of surface hardness will be described in detail in Examples.

### (2) Surface Roughness

The coating film 14 has a surface roughness of preferably 15 nm or less as measured by an atomic force microscope (AFM). Measurement conditions of surface roughness will be described in detail in Examples.

### (3) Scratch Strength

The coating film 14 has a scratch strength of preferably 8 kg or more, more preferably 9 kg or more. Measurement conditions of scratch strength will be described in detail in Examples. When the scratch strength is in this range, the surface of the glass container 10 is less likely to be scratched, and the scratch resistance is excellent. The scratch strength is greatly influenced by the surface hardness and the surface roughness of the coating film 14, and it is important that the scratch strength be in the above range.

### 3. Examples

Hereinafter, Examples of the invention and Comparative Examples will be described, but the invention is not limited to the Examples.

### 3.1. Heat Treatment Conditions in the Second Step of the Manufacturing Method

First, in order to confirm suitable conditions for the heat treatment in the second step according to the manufacturing method of the invention, tests were conducted on the relationship between the temperature of the container main body and heat treatment conditions.

### (1) Formation of Sample

As a sample, a glass container formed in the following manner by using the manufacturing apparatus 1000 illustrated in FIG. 1 was used.

A container main body (a barrel for a beer mug) was molded by a molding device 100 by using soda lime glass. Then, heat treatment was performed using an oxygen flame by a heating device (burner 210) while keeping the container main body at a predetermined temperature, and sodium in the outer surface region of the container main body was desorbed. Subsequently, a coating film of tin oxide having a film thickness of 40 nm was formed on the outer surface of the container main body with the coating film forming device 300 at a raw material gas temperature of 130° C. and a film forming time of 2 sec.

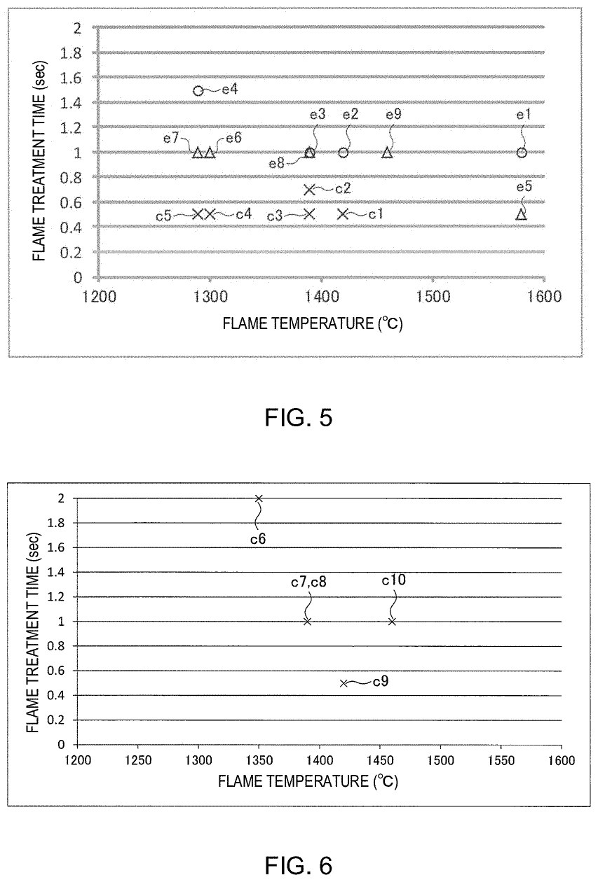

Here, the samples of Examples 1 to 9 and Comparative Examples 1 to 10 were formed by changing the flame temperature, the flame treatment time and the temperature of the container main body. The flame temperature, the flame treatment time and the temperature of the container main body of the samples are shown in Table 1 together with the results on the below-described resistance to washing in a dishwasher. FIGS. 5 and 6 also depict the results on the flame temperature, flame treatment time and resistance to washing in a dishwasher.

Further, as Comparative Examples without flame treatment, samples of Comparative Examples 11 and 12 were formed. Specifically, in Comparative Example 11, a sample was formed in the same manner as in Example 1 except that the flame treatment was not performed and the film thickness of the coating film was set to 12.5 nm. Further, in Comparative Example 12, a sample was formed in the same manner as in Example 1 except that the flame treatment was not performed and the film thickness of the coating film was set to 80 nm. It should be noted that Comparative Example 12 is in accordance with the method for manufacturing a coating film described in JP-3-131547.

TABLE 1

| | | | | Container | Coating | |
|---|---|---|---|---|---|---|
| | | Flame | Flame | main body | film | Resistance to |
| | | temperature | treatment time | temperature | thickness | washing in |
| | | (° C.) | (sec) | (° C.) | (nm) | dishwasher |
| Examples | 1 | 1580 | 1 | 600 | 40 | O |
| | 2 | 1420 | 1 | 600 | 40 | O |
| | 3 | 1390 | 1 | 630 | 40 | O |
| | 4 | 1290 | 1.5 | 600 | 40 | O |
| | 5 | 1580 | 0.5 | 600 | 40 | Δ |
| | 6 | 1300 | 1 | 600 | 40 | Δ |
| | 7 | 1290 | 1 | 600 | 40 | Δ |
| | 8 | 1390 | 1 | 580 | 40 | Δ |
| | 9 | 1460 | 1 | 580 | 40 | Δ |
| Comparative | 1 | 1420 | 0.5 | 600 | 40 | X |
| Examples | 2 | 1390 | 0.7 | 600 | 40 | X |
| | 3 | 1390 | 0.5 | 600 | 40 | X |
| | 4 | 1300 | 0.5 | 600 | 40 | X |
| | 5 | 1290 | 0.5 | 600 | 40 | X |
| | 6 | 1350 | 2 | 500 | 40 | X |
| | 7 | 1390 | 1 | 500 | 40 | X |
| | 8 | 1390 | 1 | 550 | 40 | X |
| | 9 | 1420 | 0.5 | 550 | 40 | X |
| | 10 | 1460 | 1 | 550 | 40 | X |
| | 11 | — | — | 580 | 12.5 | X |
| | 12 | — | — | 580 | 80 | X |

### (2) Test Method

Alkali resistance and resistance to washing in a dishwasher (resistance to repeated washing by a dishwasher) were investigated by the following methods.

a. Alkali Resistance

Each sample was immersed in a 0.1% sodium hydroxide solution at 65° C. for 2 h, and the whitening state of the sample was observed. The evaluation was carried out in the following manner.
Good: no whitening was observed.
Somewhat good: slight whitening was observed.
Poor: considerable bleaching was recognized.

b. Resistance to Washing in a Dishwasher

Each sample was washed repeatedly 3000 times with a commercial dishwasher, and the state of the glass containers was observed. The evaluation was carried out in the following manner. The results are depicted in Table 1 and FIGS. 5 and 6. In Table 1 and FIGS. 5 and 6, “O” indicates “good”, “Δ” indicates “somewhat good” and “X” indicates “poor”.
Good: no whitening was observed.
Somewhat good: slight whitening was observed, and the transparency of the glass container was somewhat lowered.
Poor: considerable bleaching or iris was recognized.

### (3) Test Results

a. Alkali Resistance

The samples according to Examples 1 to 4 all got “good” results and no whitening was observed. The samples according to Examples 5 to 9 all got “somewhat good” results, and the transparency of the samples was somewhat lowered.

In contrast, the samples of Comparative Examples 1 to 11 all got “poor” results and whitening was observed. In the sample of Comparative Example 12, whitening was not observed because the coating film was thick.

b. Resistance to Washing in Dishwasher

As depicted in FIGS. 5 and 6 and Table 1, the samples according to Examples 1 to 4 all got “good” results, and whitening was not observed even after washing 3000 times. The samples according to Examples 5 to 9, all got “somewhat good” results, and the transparency of the sample was somewhat lowered.

In contrast, in Comparative Examples 1 to 12, “poor” results were obtained and whitening was observed. In particular, in Comparative Example 12, a silver-white iris was observed. This is because in the sample of Comparative Example 12, an iris was originally recognized because the coating film was as thick as 80 nm, but pinholes were formed on the surface of the coating film by repeated washing with a dishwasher, whereby iridescent reflection of light on the surface further intensified the silver-white iris.

c. Conditions of Flame Treatment

FIGS. 5 and 6 and Table 1 confirm that in the step of desorbing sodium from the surface region of the container main body, it is desirable that the heat treatment (flame treatment) be performed by setting the temperature of the container main body, flame temperature and flame treatment time to appropriate ranges. In FIGS. 5 and 6, reference numerals denoted by “e” are the results of Examples, and reference numerals denoted by “c” are the results of Comparative Examples.

Specifically a correlation between the flame temperature and the flame treatment time can be found from Table 1 and FIG. 5. When the flame temperature is low, it is desirable to lengthen the flame treatment time, whereas when the flame temperature is high, it is desirable to shorten the flame treatment time. Further, as shown in Table 1 and FIG. 6, it was confirmed that where the temperature of the container main body is lower than 580° C., good resistance to washing in a dishwasher cannot be obtained even when the flame temperature is raised and the flame treatment time is extended.

From the above, it was confirmed that in the flame treatment, the temperature of the container main body is preferably 580° C. or higher, the flame temperature preferably approximately ranges from 1250° C. to 1600° C., and the flame treatment time preferably approximately ranges from 0.5 sec to 2 sec, more preferably ranges from 0.8 sec to 2 sec. In Example 5, the “somewhat good” result was obtained even when the flame treatment time was short because the flame temperature was high.

3.2. XPS analysis (Example 10, Comparative Example 13)

### (1) Formation of Sample

The container main body (barrel of beer mug) was molded by the molding device 100 by using soda lime glass. Then, in a state where the container main body was kept at 700° C., heat treatment was performed with oxygen flame by using the heating device (burner 210) at a flame temperature of 1420° C. and a flame treatment time of 1 sec to desorb sodium present in the outer surface area of the container main body. Subsequently, a coating film of tin oxide having a film thickness of 40 nm was formed on the outer surface of the container main body by using the coating film forming device 300 at a raw material gas temperature of 140° C. and a film formation time of 2 sec. In this manner, a sample of Example 10 was obtained.

A sample of Comparative Example 13 was obtained in the same manner as in Example 10 except that the flame treatment was not performed. In this case, the temperature of the container main body at the time of forming the coating film was 580° C. The manufacturing conditions of Example 10 and Comparative Example 13 are shown in Table 2.

TABLE 2

| | | | Container | Coating |
|---|---|---|---|---|
| | Flame | Flame | main body | film |
| | temperature | treatment | temperature | thickness |
| | (° C.) | time (sec) | (° C.) | (nm) |
| Example 10 | 1420 | 1 | 700 | 40 |
| Comparative | — | — | 580 | 40 |
| Example 13 | | | | |

### (2) Analysis Method

Substantially the central part of the sample of Example 10 was cut out to prepare a square sample piece with a side of about 10 mm. The XPS analysis was performed on arbitrary points of this sample piece under the following conditions. The sample of Comparative Example 13 was also subjected to the XPS analysis under the following test conditions. The results of Example 10 are illustrated in FIG. 3, and the results of Comparative Example 13 are illustrated in FIG. 4.

Conditions of XPS analysis;
Apparatus: K-alpha, manufactured by Thermo Fisher Scientific Inc.
Test conditions: beam source: Al monochromator
   measurement diameter 400 μm ϕ
   pass energy 150 eV
   measured elements: Si, Cl, C, Ca, Sn, O, Na
Sputtering condition: Ar monomer ion gun 2 kV/raster size 2 m
Sputtering progress: 1.89 nm/s

### (3) Analysis Result

As illustrated in FIG. 3, in the depth profile obtained by performing XPS analysis using the sample of Example 10, the atomic percentage (atom %) of the profile c of sodium at the point X where the profile a of tin Sn and the profile b of silicon Si intersect was about 0.5%.

In contrast, as illustrated in FIG. 4, in Comparative Example 13, the atomic percentage (atom %) of the profile c of sodium at the point X where the profile a of tin Sn and the profile b of silicon Si intersect was about 2.5%.

From FIGS. 3 and 4, in the sample of Example 10, almost no sodium is present from the surface of the coating film to a sputtering depth of about 40 nm, and the increase of sodium is gentle even at a sputtering depth of more than that. Accordingly, considering that the film thickness of the coating film was 40 nm, it was confirmed that sodium was practically not present in the coating film 40 in the sample of Example 10. In contrast, in the sample of Comparative Example 13, although sodium was hardly present from the surface of the coating film to a sputtering depth of about 35 nm, the amount of sodium abruptly increased at a sputtering depth greater than that. Therefore, considering that the film thickness of the coating film was 40 nm, it was confirmed that sodium was present in the region of the coating film 40 close to the container main body 12 in the sample of Comparative Example 13.

From the above, it was confirmed that in the present examples, the sodium concentration in the surface region of the glass of the container main body could be sufficiently reduced by flame treatment.

### 3.3. Surface Observation of Coating (Example 10, Comparative Example 13)

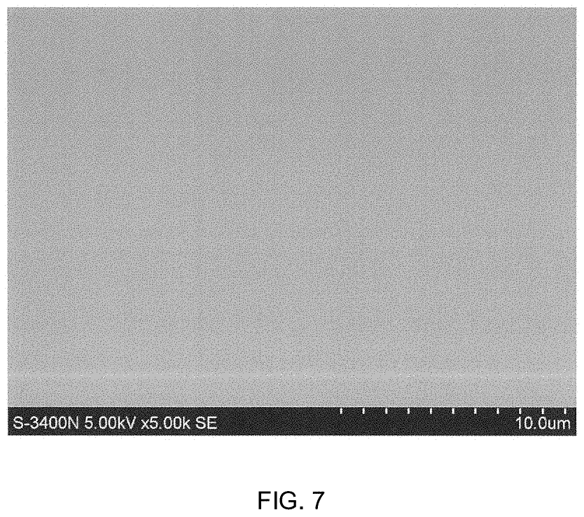

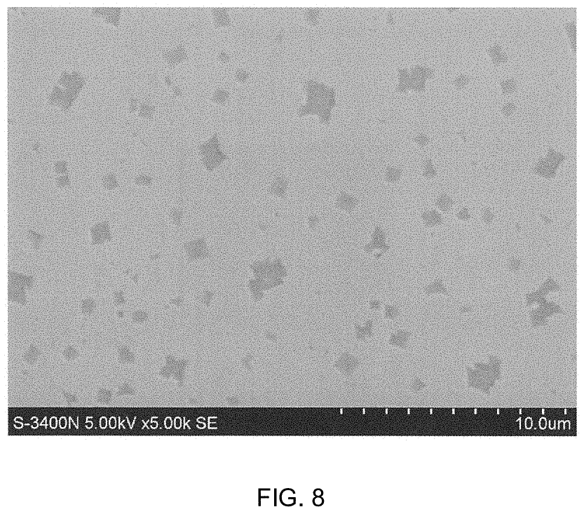

For the samples of Example 10 and Comparative Example 13, the surface of the coating film was observed with an electron microscope. The results are depicted in FIGS. 7 and 8. The magnification of the micrograph was 5000 times.

As depicted in FIG. 7, in the sample of Example 10, the surface was smooth and pinholes were not observed. In contrast, as illustrated in FIG. 8, in the sample of Comparative Example 13, a large number of pinholes were observed on the surface.

From the above, it was confirmed that the surface of the coating film can be made smooth and without pinholes by desorbing sodium present in the surface region of the container main body by heat treatment.

### 3.4. Surface Hardness of the Coating (Examples 10 and 11, Comparative Examples 11, 12, and 14)

### (1) Sample

Surface hardness of the samples of Example 10 and Example 11 was measured. In Example 11, a sample was prepared in the same manner as in Example 10, except that the film thickness of 40 nm in Example 10 was changed to 48 nm. For comparison, samples of Comparative Examples 11 and 12 and Comparative Example 14 were used. In Comparative Example 14, a sample was prepared in the same manner as in Example 10, except that the film thickness of 40 nm in Example 10 was changed to 64 nm.

### (2) Measurement Method

For each sample, the surface hardness was measured by an ultra-low loaded hardness test according to JIS Z 2255:2003. For the measurement, a square specimen with a side of about 10 mm was prepared by cutting from approximately the center of the sample glass container. An indentation hardness test was conducted under the following test conditions by using the vicinity of the apex of the curved surface of the specimen as a measurement site.
Apparatus: ultra-low loaded hardness tester ENT-1100a manufactured by ELIONIX Inc.
Test conditions: test load 0.1 mN
Indentation condition: 500 step/step interval 20 msec
Test temperature: 25° C.±1° C.

### (3) Measurement Results

The measurement results are shown in Table 3.

TABLE 3

| | | | | Comparative | Comparative | Comparative |
|---|---|---|---|---|---|---|
| | | Example 10 | Example 11 | Example 11 | Example 12 | Example 14 |
| Film | CTU | 100 | 120 | 50 | 200 | 160 |
| thickness | nm | 40 | 48 | 12.5 | 80 | 64 |

| | | | | | |
|---|---|---|---|---|---|
| Hardness (N/mm²) | 7062 | 8256 | 6798 | 8964 | 8886 |

From Table 3, it was confirmed that the surface hardness increased as the film thickness of the coating film was increased. From this measurement result, it was confirmed that the surface hardness of the present example desirably approximately ranges from 7000 N/mm² to 8500 N/mm².

### 3.5. Surface Roughness of the Coating (Examples 9 and 12, Comparative Example 12)

### (1) Sample

The surface roughness of the coating film was measured for the samples of Example 9 and Example 12. In Example 12, a sample was prepared by setting the flame temperature in the flame treatment to 1420° C., the flame treatment time to 2 sec, and the temperature of the container main body in the flame treatment to 720° C. For comparison, the sample of Comparative Example 12 was used. The production conditions of the samples of Example 12 and Comparative Example 12 are shown in Table 4.

### (2) Measurement Method

The surface roughness of the coating film was measured by an atomic force microscope (AFM) under the following conditions. For the measurement, a square specimen with a side of about 10 mm was prepared by cutting from approximately the center of the sample glass container. The surface roughness was measured by scanning the uneven state from an area of 1 μm or 10 μm on an arbitrary side from the surface of the sample piece.
Apparatus: Nanoscope (stylus type AFM) manufactured by Digital Instruments Co., Ltd.
Test conditions: scan rate 1.001 Hz
Scan size: 1 μm or 10 μm

### (3) Measurement Results

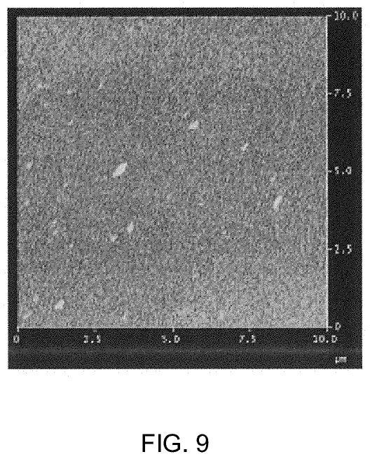

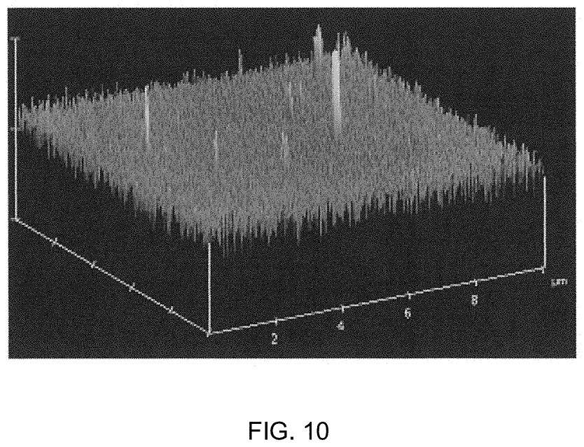

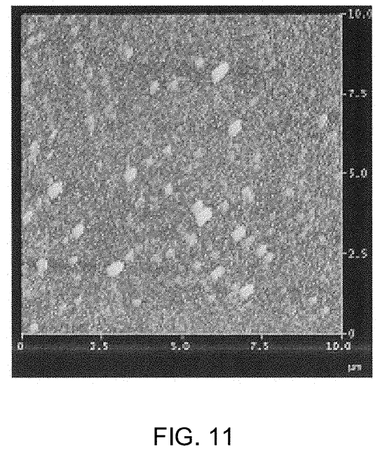

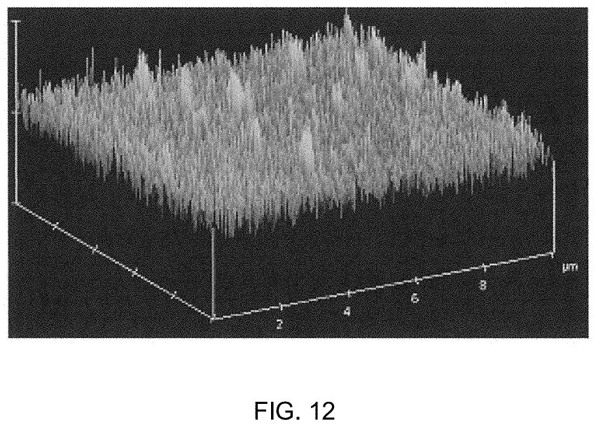

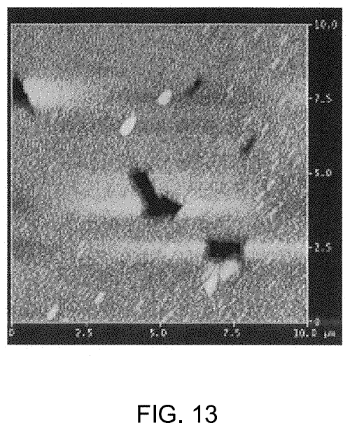

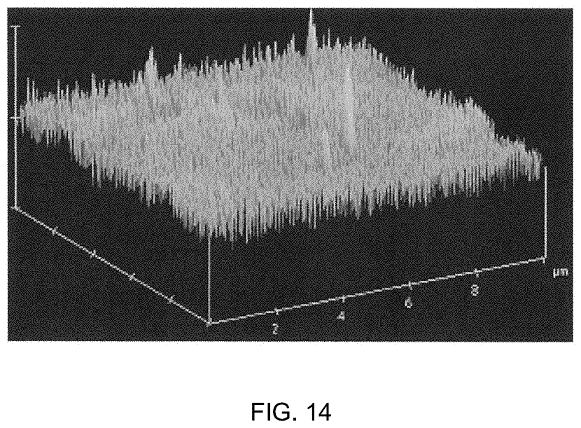

The results of Example 12 are illustrated in FIGS. 9 and 10, the results of Example 9 are illustrated in FIGS. 11 and 12, and the results of Comparative Example 12 are illustrated in FIGS. 13 and 14. From these results, in the sample of Example 12, the surface roughness (Rms) was 13.68 nm, and in the sample of Example 9, the surface roughness (Rms) was 14.34 nm. From this, it was confirmed that as the temperature of the container main body at the time of heat treatment increased, the surface roughness decreased and the crystals of the coating film became smaller.

Further, in the sample of Comparative Example 12, although the crystals of the coating film were small, because the pinholes were generated, the surface roughness was 17.49 nm.

### 3.6. Scratch Strength of Glass Container

### (1) Sample

The samples of Examples 12 to 15 were prepared by setting the flame treatment conditions, the temperature of the container main body in the heating step, and the film thickness of the coating film as shown in Table 4. The samples of Comparative Examples 11 to 13 and 15 were all prepared without flame treatment by setting the conditions relating to the temperature of the container main body and the film thickness of the coating film as shown in Table 4. Comparative Example 16 is an example in which no film is formed.

### (2) Measurement Method

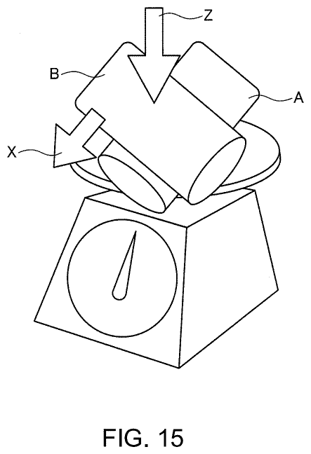

As illustrated in FIG. 15, a sample A is placed horizontally on a weighing instrument (automatic weighing instrument), and the weight is reset to zero. Then, a sample B is brought into contact with the sample A and the sample B is rubbed in the direction from the body part toward the mouth part of the sample A, as shown by arrow X, while maintaining a state in which the sample B is pressed with an arbitrary load from above, as shown by arrow Z. When scratches did not occur, the same test was repeated while increasing the pressing load by 1 kg, and the load at which a scratch occurred on the surface of the sample A was determined.

### (3) Measurement Results

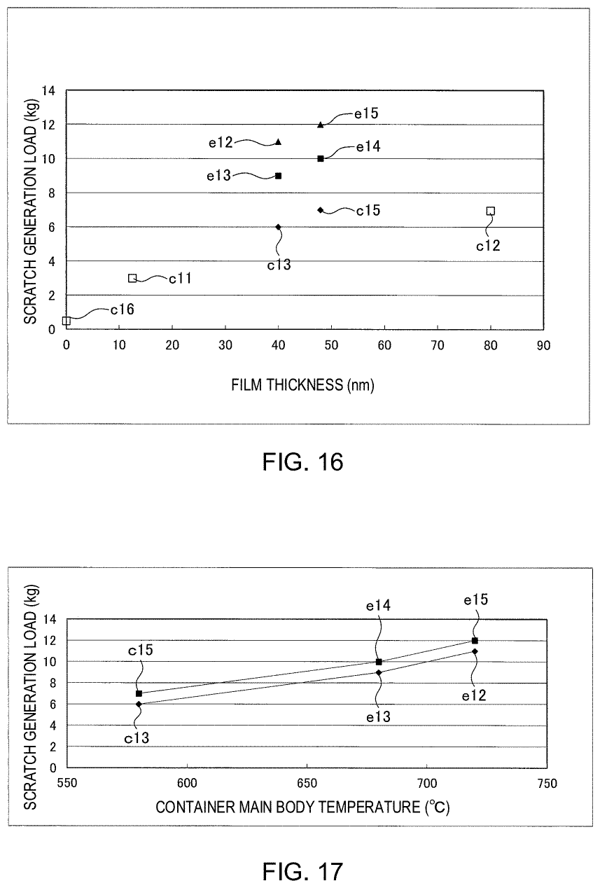

The measurement results are shown in Table 4 and FIGS. 16 and 17. FIG. 16 illustrates the relationship between the film thickness of the coating film and the scratch generation load, and FIG. 17 illustrates the relationship between the temperature of the container main body in the heat treatment and the scratch generation load. In FIGS. 16 and 17, reference numerals denoted by “e” are the results of Examples, and reference numerals denoted by “c” are the results of Comparative Examples.

TABLE 4

| | | Flame treatment conditions | | Container | | | |
|---|---|---|---|---|---|---|---|
| | | Flame | Flame | main body | Coating film | | Scratch |
| | | temperature | treatment | temperature | thickness | | strength |
| | | (° C.) | time (sec) | (° C.) | cm | nm | (kg) |
| Examples | 12 | 1420 | 2 sec | 720 | 100 | 40 | 11 |
| | 13 | 1420 | 1 sec | 680 | 100 | 40 | 9 |
| | 14 | 1420 | 1 sec | 680 | 120 | 48 | 10 |
| | 15 | 1420 | 2 sec | 720 | 120 | 48 | 12 |
| Comparative | 11 | — | — | 580 | 50 | 12.5 | 3 |
| Examples | 12 | — | — | 580 | 200 | 80 | 7 |
| | 13 | — | — | 580 | 100 | 40 | 6 |
| | 15 | — | — | 580 | 120 | 48 | 7 |
| | 16 | — | — | 580 | 0 | 0 | 0.5 |

As shown in Table 4 and FIGS. 16 and 17, it was confirmed that in the samples of Examples 12 to 15, the scratch strength increased as the film thickness of the film became larger. This trend is the same also in Comparative Examples not subjected to the flame treatment, but from the results of the samples of Comparative Examples 13 and 15, it was confirmed that these samples did not have a sufficient scratch strength. In the case of Comparative Example 11 in which the film thickness of the coating film was too small, the scratch strength was considerably small, whereas in Comparative Example 12, it was confirmed that sufficient scratch strength could not be obtained despite a rather large film thickness of the coating film.

Further, as shown in Table 4 and FIG. 17, there is a correlation between the temperature of the container main body during the flame treatment and the scratch strength. In the samples of Examples 12 to 15, it was confirmed that the higher the temperature of the container main body, the greater the scratch strength.

### 3.7. Summary

As described above, according to the Examples of the invention, by removing sodium in the surface region of the container main body or reducing the amount thereof, very good results could be obtained for alkali resistance, smoothness of the coating film surface, surface hardness, surface roughness and scratch strength. As a result, the glass container of the invention excels in scratch resistance, alkali resistance, resistance to washing in a dishwasher and the like, shows no iris generation and excels in aesthetic appearance.

The invention is not limited to the above-described embodiments, and various modifications thereof are possible. For example, the invention includes various other configurations that are substantially identical to the configurations described in the embodiments (for example, configurations having identical functions, methods, and results or configurations having identical objectives and effects). The invention also includes various other configurations in which non-essential elements described in the embodiments are replaced by other elements. The invention also includes various other configurations having the same effects as those of the configurations described in the embodiments, or various other configurations capable of achieving the same objectives as those of the configurations described in the embodiments. Furthermore, the invention includes various other configurations in which known techniques are added to the configurations described in the embodiments.

What is claimed is:

1. A method for manufacturing a glass container comprising:
a first step of molding a container main body made of glass;
a second step of conducting heat treatment while maintaining the container main body at a temperature of 580° C. or higher to desorb sodium in a surface region of the container main body; and
a third step of forming a coating film of tin oxide or titanium oxide having a film thickness ranging from 40 nm to 50 nm on a surface of the container main body.

2. The method for manufacturing a glass container according to claim 1,
wherein the temperature of the container main body in the second step ranges from 600° C. to 770° C.

3. The method for manufacturing a glass container according to claim 1,
wherein the heat treatment in the second step is a flame treatment.

4. The method for manufacturing a glass container according to claim 3,
wherein, in the flame treatment, the flame temperature ranges from 1250° C. to 1600° C., and the flame contact time ranges from 0.5 sec to 2 sec.

5. The method for manufacturing a glass container according to claim 3,
wherein, in the flame treatment, the flame temperature ranges from 1290° C. to 1580° C., and the flame contact time ranges from 0.8 sec to 2 sec.
